(19) United States
(12) Patent Application Publication
(10) Pub. No.: US 2010/0206773 A1
(43) Pub. Date: Aug. 19, 2010

(54) Conversion of a light sweet refinery to a heavy sour refinery

(75) Inventors: Calvin T. Case, Findlay, OH (US); Dennis W. Keppers, Findlay, OH (US); Vernon W. Mark, Findlay, OH (US)

Correspondence Address: EMCH, SCHAFFER, SCHAUB & PORCELLO CO, P O BOX 916, ONE SEAGATE SUITE 1980, TOLEDO, OH, 43697, US

(73) Assignee: Marathon Petroleum Company LLC

(21) Appl. No.: 12/378,610

(22) Filed: Feb. 18, 2009

(51) Int. Cl. C10G 47/00; B01J 19/00

(52) U.S. Cl. 208/107; 422/211

(57) ABSTRACT

This is a unique way of upgrading an existing refinery to process heavy sour crude. The system does not significantly modify an existing sweet refinery. Rather, a hydrocracker is used at the existing light sweet refinery location to create light sweet crudes from heavy sour crudes prior to processing in an existing sweet refinery.

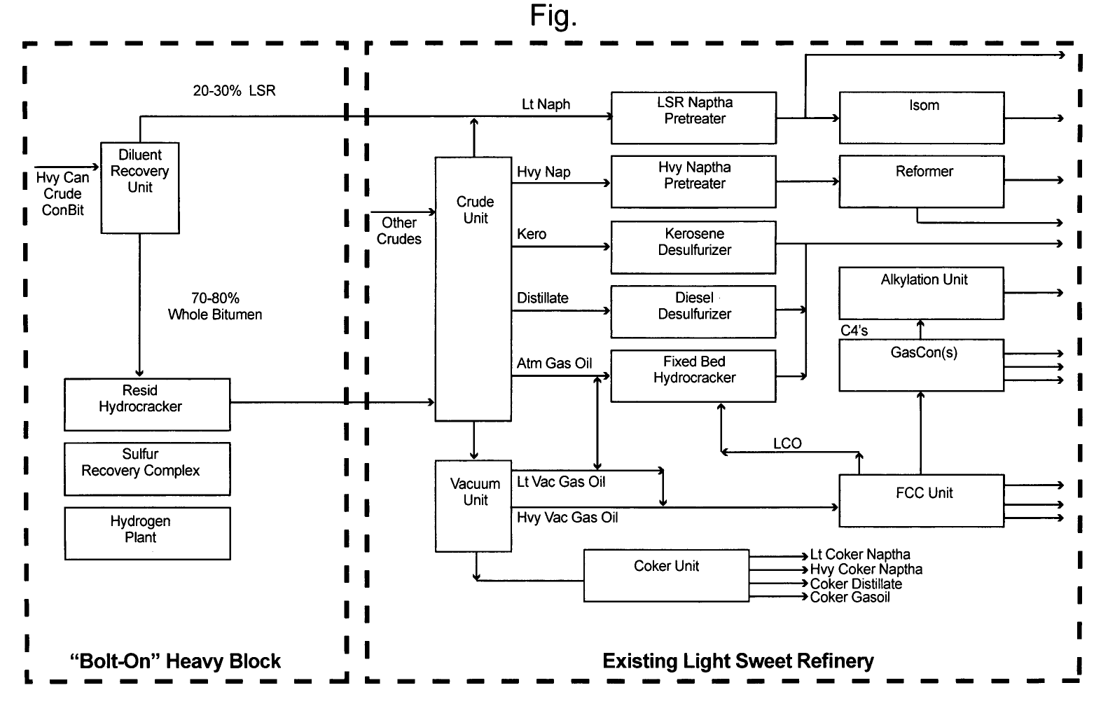

### TECHNICAL FIELD OF THE INVENTION

This invention relates to the conversion of a light sweet refinery to a heavy sour refinery through the up front addition of a resid hydrocracker.

### BACKGROUND OF THE INVENTION

The following are two ways in which a refiner can produce low-sulphur transport fuel. The first is to process a predominantly light sweet crude through distillation and reaction processes to produce primarily light transportation products. A second option is to process a heavy sour crude oil that requires significantly more equipment to upgrade the heavier fraction called resid to light products. This heavy sour upgrading has additional equipment requirements to reduce the boiling range of the resid and reduce other crude contaminants such as corrosive acids, nitrogen and sulfur. The heavy sour crude prices are discounted due to their processing issues which may make them economically attractive to refine.

Extensive reserves in the form of “heavy crudes” exist in a number of countries, including Western Canada, Venezuela, Russia, the United States, and elsewhere. These deposits of heavy crudes often exist in areas that are inaccessible by normal means. Generally, the term “heavy crudes” refers to a hydrocarbon material having an API gravity of less than 25.

Many of the Western Canadian heavy crudes are produced by blending an even heavier bitumen with an API gravity of roughly 6 to 12 with a diluent to have a blended API gravity of approximately 19 to 25. In this case, the bitumen is the difficult to process component

It can cost billions of dollars to retrofit a light sweet refinery to process heavy sour crude. Almost every process unit may require retrofitting due to its different boiling range and contaminants. There are concerns that the costs of converting refineries to process heavy sour crude will be hard to recoup. Long term, the ability to use heavy sour crude is an issue that's expected to confront the refining industry for an extended period of time.

### SUMMARY OF THE INVENTION

Rather than incur the cost of extensively retrofitting an existing light sweet refinery, we have invented a unique way of conditioning the heavy sour crude at the refinery location to make it acceptable for processing in the existing light sweet refinery equipment. Our system does not significantly modify an existing sweet refinery. Rather, we use a resid hydrocracker to condition bitumens or heavy sour crudes prior to processing in an existing sweet refinery.

Refineries and Resid Hydrocrackers are both known processes. This invention utilizes the Resid Hydrocracker in a new and innovative way to more efficiently convert a Light Sweet (or moderately heavy/sour) Refinery into a Heavy Sour Refinery. This process feeds a whole or topped crude (atmospheric or vacuum) into a resid hydrocracker (e.g. LC-Fining or H-Oil) at the refinery to upgrade the Heavy Sour crude into a light sweet crude prior to feeding it into the existing refinery. This process is conducted at the refinery site, but upstream of the existing refinery. The primary benefit of this invention is that it creates a crude feedstock that an existing light sweet refinery can process without significant modifications. This benefit includes sulfur reduction, nitrogen reduction, removal or corrosive acids and the upgrading of the resid. More specific benefits of this processing scheme include that it significantly reduces the existing refinery's hydrotreater revamp work, it eliminates the fractionation equipment in the resid Hydrocracker and it efficiently utilizes any existing bottoms upgrading equipment (e.g. coker, gasification, SDA, etc.)

Other objects and advantages of the present invention will become apparent to those skilled in the art upon a review of the following detailed description of the preferred embodiments and the accompanying drawings.

### BRIEF DESCRIPTION OF THE DRAWINGS

The FIGURE is a block diagram example of this invention with a resid hydrocracker upstream of a typical existing light sweet refinery.

### DETAILED DESCRIPTION OF THE INVENTION

This invention is a hydrotreating process and apparatus for upgrading an existing refinery to process a heavy hydrocarbonaceous feedstock of heavy oil or heavy bitumen. The process comprises the steps of providing a heavy hydrocarbonaceous feedstock, and feeding the heavy hydrocarbonaceous feedstock to a Resid Hydrocracker. The recovered hydrocarbonaceous feedstock has a boiling point which is lower than the boiling point of the heavy hydrocarbonaceous feedstock and contains reduced levels of sulfur, nitrogen and corrosive organic acids. The recovered lowered boiling point hydrocarbonaceous feedstock then is fed from the Resid Hydrocracking unit to an existing refinery. The heavy hydrocarbonaceous feedstock typically is a heavy sour crude or bitumen.

The FIGURE is a block diagram of a resid hydrocracker according to this invention in combination with a typical existing sweet refinery. Heavy sour crude is fed to a resid hydrocracker unit.

A recovered lowered boiling point hydrocarbonaceous feedstock with less sulfur, nitrogen and corrosive organic acids from the Resid Hydrocracker unit is fed to a primary fractionation tower in an existing refinery.

During resid hydrotreating, resid oil is upgraded with hydrogen and a hydrotreating catalyst to produce more valuable lower-boiling liquid products.

Conventional resid hydroprocessing typically include one or more reactors that comprise a reaction chamber, a port at the bottom of the reaction chamber through which a heavy oil feedstock and pressurized hydrogen gas are introduced, a port at the top of the reaction chamber through which fresh catalyst is introduced, a recycle cup and conduit in the center of the reaction chamber, an expanded catalyst zone, an ebullating pump that circulates the reactor liquid down through the recycle cup and conduit and up through the expanded catalyst zone, a first catalyst free zone at the reactor bottom (or plenum), a second catalyst free zone above the expanded catalyst zone, a port at the top of the reaction chamber through which an upgraded feedstock is withdrawn from the second catalyst free zone, and a port at the bottom of the reaction chamber through which spent catalyst is withdrawn. Circulation of the heavy oil feedstock upwards through the expanded catalyst zone maintains the solid supported catalyst in an expanded, or fluidized state. It also helps equalize the temperature of the feedstock throughout the reaction chamber.

The resid hydrocracker reactor typically operates with a hydrogen partial pressure between 1000 and 3000 psig and a temperature between 370 and 470° C. A fixed-bed, down-flow resid hydrotreater reactor may be employed at the lower range of these temperatures (about 370 to 425° C.). The heavy oil residence time in the resid hydrocracker reactor is adjusted such that the quantity of hydrogen added to the oil meets or exceeds the requirements of the subsequent hydrogen donor cracking process step. The residence time is typically about 5 to 60 minutes.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. A process for upgrading an existing refinery to condition a heavy hydrocarbonaceous feedstock of heavy oil or heavy bitumen to be processed in an existing light sweet refinery comprising the steps of:
providing a heavy hydrocarbonaceous feedstock;
feeding the heavy hydrocarbonaceous feedstock to a Resid Hydrocracker;
recovering a hydrocarbonaceous feedstock having a boiling point which is lower than the boiling point of the heavy hydrocarbonaceous feedstock with less sulfur, nitrogen and corrosive acids; and
feeding the recovered lowered boiling point hydrocarbonaceous feedstock with less sulfur, nitrogen and corrosive acids from the Resid Hydrocracker unit to an existing refinery.

2. A process according to claim 1 wherein the heavy hydrocarbonaceous feedstock is a heavy sour crude.

3. A process according to claim 1 wherein the existing refinery is an existing light sweet refinery.

4. A hydrotreating apparatus for upgrading an existing refinery to process a heavy hydrocarbonaceous feedstock of heavy oil or heavy bitumen comprising:
providing a heavy hydrocarbonaceous feedstock;
a Resid Hydrocracker;
a means for feeding the heavy hydrocarbonaceous feedstock to the Resid Hydrocracker unit;
a means for recovering a hydrocarbonaceous feedstock from the Resid Hydrocracking unit having a boiling point which is lower than the boiling point of the heavy hydrocarbonaceous feedstock with less sulfur, nitrogen and corrosive acids; and
a means for feeding the recovered lowered boiling point hydrocarbonaceous feedstock from the Resid Hydrocracking unit to an existing refinery.

5. An apparatus according to claim 3 wherein the existing refinery is an existing sweet refinery.
